(19) United States
(12) Patent Application Publication
(10) Pub. No.: US 2009/0064872 A1
(43) Pub. Date: Mar. 12, 2009

(54) Multi-Sectioned Replacement Grill Grate Section

(76) Inventor: Kenneth Zisserson, Plymouth, MA (US)

Correspondence Address: LAMBERT & ASSOCIATES, P.L.L.C., 92 STATE STREET, BOSTON, MA, 02109-2004, US

(21) Appl. No.: 11/854,062

(22) Filed: Sep. 12, 2007

(51) Int. Cl. A47J 37/07; B23P 11/00

(52) U.S. Cl. 99/450; 29/428; 126/152 R

(57) ABSTRACT

A grill grate replacement system that has multiple, separately attachable grill grate sections. These grill grates are designed so that when all grill grates are used with one another they utilize the entire grilling area of the grill for which they are intended, while giving grillers easy access to the fuel source by allowing removal of only selected sections of the grill grate system. The system uses a material that provides strength and rigidity, such as cast-iron, and a coating material, such as porcelain, that protects against weathering and provides a non-stick surface. Support systems for this replacement grill grate system conform to the shape of the grill for which they are intended for use, and are made of a rigid material for strength, such as stainless steel.

### FIELD OF THE INVENTION

The present invention relates generally to grill grating systems and particularly to the development of separate removable grill grate sections that provide longer life, easier cleaning, maximize cooking surfaces and improve the grilling experience by leaving more aesthetically pleasing grill marks.

### REFERENCES

In general within the art, descriptions of grill grating systems and their various related elements can be found in Ser. No. 291,855 set forth by Erback et al; and U.S. Pat. No. 5,730,114 by Fabrikant et al. and U.S. Pat. No. 7,093,340 by Groll; and U.S. Pat. No. 5,490,452 by Schlosser et al.; and U.S. Pat. No. 5,259,299 by Ferraro.

### BACKGROUND OF INVENTION

This invention relates to grill grating systems that involve multiple grate sections. The various component elements of the invention include center grill grate sections, left and right grill grate sections and a support system to elevate the grill grate sections over the grill heat source.

As pointed out in the in above-referenced US patents, the previous grill grating systems fail to allow for most of the features that this invention provides, and none provide a total solution that combines longevity, a stick-resistant surface, utilization of the full grilling area, the ability to leave desirable grill marks, and decreasing the cooking surface stickiness preventing the tearing of food. Further, prior systems featuring vertical movement of grill grates do not allow for easy access to the grilling fuel source. Additionally, non-stick grilling surfaces do not address the failure to resist easy wear issues, such as rusting, often encountered by such materials. Moreover use of cooking inserts limits the cooking area and deprives users the satisfaction of creating aesthetically pleasing lines on their food.

What is needed is a grill grate replacement system exhibiting a long lifespan and an easy to clean non-stick surface that maintains the full grilling surface area along with providing easy access to the grilling fuel source. In addition, what is needed is a system that provides well defined, satisfying grill marks.

### SUMMARY OF THE INVENTION

The instant invention, as illustrated herein, is clearly not anticipated, rendered obvious, or even present in any of the prior art mechanisms, either alone or in any combination thereof. A grilling system designed to overcome the previously mentioned shortcomings would give grillers a much fuller and satisfying grilling experience. Thus the several embodiments of the instant invention are illustrated herein.

The invention devises a grill grate replacement system that is divided into two or more sections, and a support system upon which the grill grate sections rest when placed inside a grill.

The invention uses an internal material that provides strength and rigidity. This material is then manufactured into bars of an appropriate length and diameter as needed to fit within the dimensions of the grill for which they are intended to be used. These bars are then covered with a durable and easy to clean material that can withstand both heat and weathering. The bars (further referred to as placement bars) are then used to form the grilling surface upon which food and other grilled items will be placed for grilling. These placement bars contact at least two other grill grate sections.

The number of grill grate sections and the dimensions of each grate section vary, but are always appropriate to fit within whatever type of grill the grate sections are intended to be used for, but without losing any of the grilling surface.

In one embodiment the grill grate sections are comprised of the same material as the placement bars. The shape and dimensions of any given sectional-perimeter bar will cover one section of the grill in such a manner that, when placed beside its neighboring sectional-perimeter bar, and when all perimeter bars have been laid out next to each other, the entire perimeter of the grilling surface area will be covered. Once the shape and dimensions of a sectional-perimeter bar has been set, then placement bars of appropriate lengths attached to the sectional-perimeter bar so as to conform to the size and dimensions of the sectional-perimeter bar. The lengths of these placement bars are such that they contact the sectional-perimeter bar to which they are intended, but do not extend beyond the sectional-perimeter bar's edge. Crossbars are attached by their endpoints to the perimeter bar in such a way that they run perpendicular to and intersect the placement bars. The cross bars are in turn attached to the placement bars at their respective intersection points.

In another embodiment, all the parts of each grill grate section are comprised of the same material as the above mentioned placement bars. Further, in this embodiment the individual grill grate sections are created as one entire unit. That is, the placement bars, cross bars and perimeter bars of a given section all lay in the same plane with each other, contacting their neighboring pieces on their sides only. In this embodiment the individual grill grate sections lay next to one another so as to cover the entire grilling surface of the grill for which they were intended.

The grill grate sections of the above mentioned embodiments in turn rest upon a support system. This support system is comprised of a rigid material that resists weathering and high temperatures that is then made into one or more bars. One or more support system bars will be used to make the support-system perimeter bar. The number, size and dimensions of the bars will vary so as to both cover the grilling area for the grill selected while still ably supporting all the grill grate sections when they are all properly laid next to their appropriate neighboring grill grate section or sections. The support system cross bars are attached to the grill grate perimeter bar by their end points, at appropriate positions to provide additional support and strength to the support-system perimeter bar so that it adequately supports itself and the grill grate sections while lying within the grill for which it was intended.

In one embodiment the invention uses three grill grate sections, a center grill grate section, a left grill grate section and a right grill grate section. The placement and perimeter bars of all three grill grate sections are constructed in the manner mentioned above, where the internal material that provides rigidity and strength is cast-iron, and the durable, weather resistant, material covering the bars is porcelain.

The center grill grate section may further be constructed by using a total of eighteen porcelain coated cast-iron bars with the bars allocated in the following manner;

1) Four bars for the center grill grate section;

2) Thirteen bars used as placement bars; and

3) One bar as a cross bar.

Two of the four bars used in the perimeter bar may be curved in such a manner that the perimeter bar's endpoints are 11.9375″ apart, while the deepest part of the curve is 3.1″ at the curved bar's midpoint. The remaining two straight bars have a 18.4″ length and are attached to each curved bar such that the endpoints of the straight bars are attached to the end points of the curved bars so as to form a four-sided shape with two curved sides and two straight sides.

The center grill grate section is completed by attaching a cross bar, of length 11.9375″ to the midpoints of each straight side of the perimeter bar at its endpoints. Placement bars are then attached on top of the perimeter-bar cross-bar piece, where each of the two shortest placement bars, each of length 18.4″, are attached on one of the two straight sides of the perimeter bar. From there additional placement bars of gradually increasing length that contact, but do not extend over, the curved side of the perimeter bar, are laid one-half inch away from their neighboring placement bar or bars. More placement bars are added in this manner until no gaps greater then a half-inch in width remain on the newly created grilling surface. These placement bars are then all attached to the crossbar at their respective midpoints and to the curved sides of the perimeter bar at their respective endpoints.

The left-section and right-section grill grates of this embodiment use the same cast-iron, porcelain coated bars mentioned above and require eight bars, allocated in the following manner:

1) Five bars used as placement bars;

2) Two bars as perimeter bars; and

3) One bar as a cross bar.

The perimeter bars of these sections each have one curved bar and one straight bar. The curved bars are 18.4″ wide from endpoint to endpoint, while 4.75″ deep at their center points. A straight bar of 18.4″ is then attached to the curved bar at their respective endpoints. This gives the perimeter bar two sides, one curved and one straight. A cross bar of 4.75″ is attached at its endpoints to the midpoints of the center point of the curved side of the perimeter bad and the center point of the straight bar, completing a perimeter-bar with an attached cross-bar piece.

The left-section and right section grill grates are then completed by laying placement bars over the perimeter-bar, with the longest placement bar of 18.4″ laying over the 18.4″ straight side of the perimeter bar. Additional placement bars are lay one-half inch away from any neighboring placement bar, moving from the straight side of the perimeter bar towards the narrower curved section. The placement bars are all laid down so that the ends of the placement bars contact but do not extend over, the curved edge of the perimeter bar. All the placement bars are attached to the perimeter-bar and cross bar at all contact points.

The grill grate support system is made of two, three-quarter inch thick stainless steel pieces, one circular ring, and a straight cross-bar. The cross bar is 20″ in length and is attached at its end points to the circular ring. The circular ring has a 20″ diameter on its inside and a 21.5″ diameter on its outer side. This allows for the cross bar to fit within the ring from endpoint to endpoint.

A second embodiment of the grill grate support system is comprised of three three-quarter inch thick stainless steel pieces, one circular ring, and two straight cross-bars. The circular ring has a 20″ diameter on its inside, and a 21.5″ diameter on its outside. Each of the straight bars of 17″ length are attached to the circular ring at their endpoints. The cross bars are laid parallel to each other, so that if a perpendicular line were drawn from the straight bars at their midpoints, the distance between the straight bar and the circular ring along that line would be 4.75″, leaving 12″ distance between the cross bars.

### BRIEF DESCRIPTION OF THE DRAWINGS

FIG. 1 illustrates a view of a center section grill grate for use in grills with a circular design. Visible here are a perimeter having two straight sides and two curved sides, fifteen placement bars, and one cross bar. The placement bars are placed parallel to each other with equidistant spacing between them and the bars are arranged so that the endpoints of all placement bars contact but do not extend over the perimeter bar's edge. The cross bar runs from midpoints of the perimeter bar's straight sides while lying underneath and perpendicular to the placement bars.

FIG. 2 illustrates a view of the left and right section grill grates for use with grills that have a circular design. The perimeter of each piece can be seen having a curved side and a straight side. The cross bar runs from the mid-point of the straight side to the mid-point of the curved side. Over the left and right section crossbars and perimeter bars are laid the left and right section placement bars. The bars are laid next to each other with equidistant spacing between them, so that their endpoints touch, but do not extend beyond the curve of the perimeter bar's curved side.

FIG. 3 illustrates a view of a support system for use with grills that have a circular design. Visible, are two cross bars and one circular perimeter bar. The figure shows the cross bars lying parallel to one another and making contact with the perimeter bar not extending beyond the boarder of the perimeter bar. Further, the two cross bars are of equal length and are equidistant from their respective sides of the perimeter bar.

FIG. 4 illustrates a view of a support system for use with grills that have a circular design. There are visible two pieces, a circular perimeter bar and a single straight crossbar. The crossbar lays in the circular perimeter bar so as to cover span the full diameter of the perimeter bar, make contact with the perimeter bar, but without extending beyond the perimeter bars edge.

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as replacement grill grate systems with different numbers of grill grate sections, as well as those with different shapes and dimensions.

Grill grate replacement systems have failed to meet grillers' needs in several different ways. Most replacement systems do not provide non-stick grilling surfaces that are easy to clean and have a long life. Other systems also do not preserve the full grilling surface while leaving aesthetically pleasing grill marks. Further, some make attempts to provide grillers access to the fuel source but fail to provide grillers with an easy means of access to the fuel source.

The present invention solves all these shortcomings found in other replacement grill grate systems. The porcelain enameled cast-iron material used in constructing the present invention provides a weather resistant surface giving the grill grates long life, and a non-stick, easy-to-clean surface. By using grill grates of appropriate dimensions and sizes to match the grills for which they were designed, and avoiding awkward inserts that don't fit the grilling surface area, the invention maintains the full grilling surface and also maintains the aesthetically desirable grill marks. In addition the separately detachable section design does not limit the choices of grillers in deciding from which grill grate sections through which they would like to have access to the fuel source. By using separately detachable grill grates, the sides, the center or any sectional part of the grilling surface may be removed to give easy access to the fuel source.

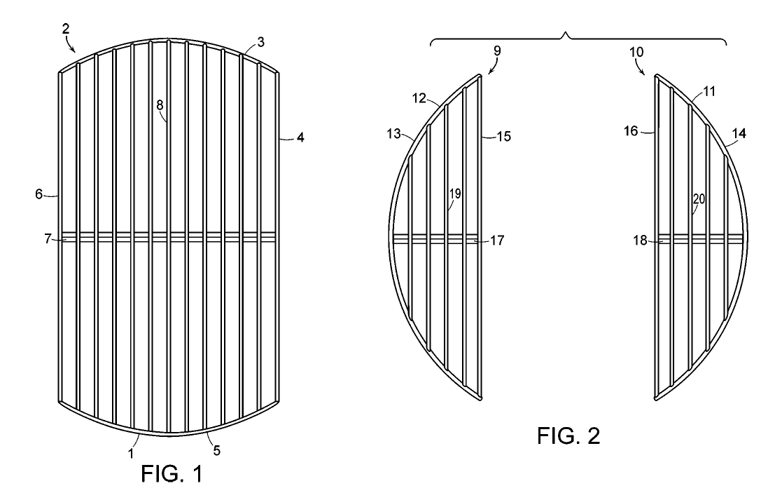

FIG. 1 shows the center grill grate section for a three-pieced removable grill grate system comprising a center grill grate 1 and left and right grill grate sections 9 and 10 as seen in FIG. 2. All the construction bars are made of cast-iron with a porcelain enamel finish. This center grill grate section has a center-section perimeter bar 2, comprised of two curved sides 3 and 5, and also two straight sides 4 and 6. The endpoints of the curved sides 3 and 5 are 11.9375″ apart, with a curve depth of 3.1″. The lengths of the two straight sides 4 and 6 are 18.4″. The endpoints of sides 3 and 5 are attached to the endpoints of 4 and 6 respectively, so as to form a four-sided shape with two straight sides and two curved sides. The endpoints of cross bar 7 are attached to the two straight sides 4 and 6 at their respective midpoints with said crossbar having a length of 11.9375″. The fifteen placement bars 8, all lay parallel and equally spaced away from one another. These placement bars 8 may rest on or in the same plane with the perimeter bar and cross bar but are so arranged that the placement bars 8 are parallel to the perimeter bar straight sides 4 and 6 and perpendicular to the cross bar 7. The ends of these placement bars 8 rest on the curved sides of the perimeter bar 3 and 5 or lay next to said perimeter bars in the same plane. The ends of the placement bars make contact with, but do not extend over the edge of said curved sides when resting on the perimeter bar. When resting in the same plane with said perimeter bar said ends extend only to the point of contacting the curved sides of said perimeter bar. The individual lengths of the placement bars are determined in this manner. All placement bars, cross bars and perimeter bars have a four-sided cross section, with its top having a 0.25″ width and bottom width of 0.375″.

FIG. 2 illustrates the left and right grill grate sections for a three-pieced removable grill system comprising a center grill grate section 1 and left and right grill grate sections 9 and 10 respectively. All the bars used in 9 and 10 are comprised of the same cast-iron porcelain enameled material used in the center grill grate section 1. Each left and right grill grate section 9 and 10 has a left and right perimeter bar 11 and 12 respectively. Each of these perimeter bars 11 and 12 are comprised of curved sides 13 and 14 respectively and a straight sides 15 and 16 respectively. The lengths of straight sides 15 and 16 are 18.4″. The curved sides 13 and 14 have endpoints 18.4″ apart with a curve depth of 4.75″. The left and right cross bars 17 and 18 respectively are attached at their endpoints to the midpoints of the perimeter bar's straight sides 15 and 16, and the perimeter bar's curved sides 13 and 14. The cross bars 17 and 18 have a length of 4.75″. Five left and right placement bars 19 and 20 respectively rest on or lay in the same plane with the left and right perimeter bars 11 and 12 and the left and right cross bars 17 and 18 are. The placement bars are laid parallel to the straight sides of the perimeter bars 15 and 16 as well as parallel to each other. Further, these placement bars rest on or in the same plane with the curved side of the perimeter bars 13 and 14. The end points of said placement bars 19 and 20 contact, but do not extend beyond the curved edges of 13 and 14 when said placement bars rest over said curved sides but extend only to the point of contact with the curved sides of the said perimeter bars when laying in the same plane. The placement bars also lay over or in the same plane with to the cross bars 17 and 18 in a perpendicular manner with said cross bars. The placement bars 19 and 20 are attached at all points of contact with the perimeter bars 11 and 12 as well as the cross bars 17 and 18. All placement bars, cross bars and perimeter bars have a four-sided cross section, with a top width of 0.25″ and bottom width of 0.375″.

In other embodiments of the invention there may include multiple center grill grate sections or no center grill grate sections so as to provide multiple access points for convenient access to the fuel source. In these embodiments the shape, dimensions and number of pieces used in constructing perimeter bars may vary so that they may best conform to the shape of the grill they were intended or to the shape and dimensions of their neighboring pieces. Other embodiments may also vary in number, dimension and spacing distance between placement bars so as to provide a variety of grilling surfaces for various grilling needs. In these other embodiments, the materials utilized to construct the several pieces of center section grill grates may vary. Other embodiments feature center grill grate sections neighbored by one or more sides by other center grill grate sections. The cross bars used in center grill grate sections may vary in number and dimensions so as to provide adequate support for the center grill grate section. The placement bars in these other embodiments may also vary in their number, dimensions, and shape so as to provide a variety of grilling surfaces. In these other embodiments the separate grill grate sections may be created by attaching the individual pieces together by an attaching means (attaching the placement bars, cross bars and perimeter bars together) or the grill grate section may be constructed all in one unit.

In other embodiments there may be no center grill grate section. This would be in cases where access to the fuel source may be easily obtained via removal of a left or right grill grate section alone.

In other embodiments the left and right grill grate sections may vary in shape and dimension so as to conform to the shape and dimensions of the grill they are intended for use with. The perimeter bars of left and right grill grate sections may also vary in the number of pieces comprising them, their shape and dimensions so as to conform to the contours of the grill for which they are designed. In these other embodiments the left and right grill grate sections may be neighbored by none or more center grill grate sections. The cross bars used in left and right grill grate sections may also vary in number and dimensions so as to provide adequate support for the center grill grate section. The placement bars in these other embodiments may vary in their number, dimensions, and shape so as to provide a variety of grilling surfaces.

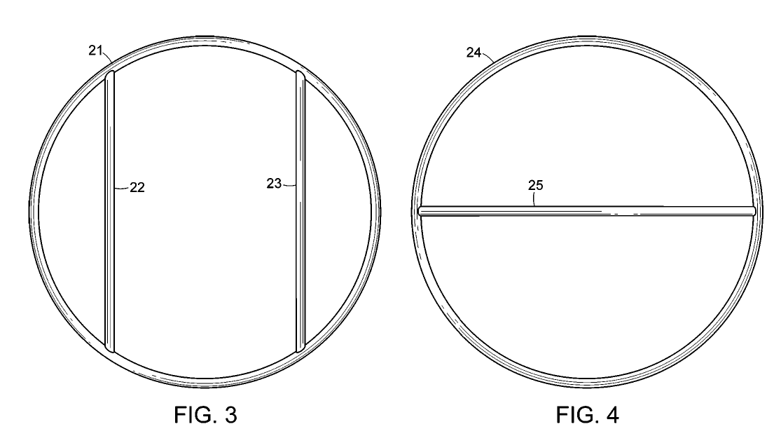

FIG. 3 illustrates one embodiment of a grill grate support system for use in circularly designed grills. The figure shows three stainless steel pieces, one circular ring 21 and two straight cross bars 22 and 23. In this embodiment all three pieces 21, 22 and 23 have a diameter of 0.75″. Both cross bars 22 and 23 are of the same length and are lying within the circular ring, parallel to each other while being attached to the circular ring by their endpoints. Both cross bars 22, 23 are located the same distance away from their respective sides of the circular ring, as measured from a perpendicular line from their midpoints to the circular ring 21.

FIG. 4 illustrates another embodiment of a grill grate support system for use in circularly designed grills. This embodiment uses two stainless steel pieces with a thickness of 0.75″ in diameter, said pieces being a circular ring 24 and a cross bar 25. The endpoints of crossbar 25 are attached to the circular ring 24 so that the endpoints of the crossbar 25 run along the diameter of the do not extend beyond the outer edge of the circular ring 24. In this embodiment the crossbar 25 has a length of 20″ and the circular ring 24 has an inner diameter of 20″ and an outer of diameter of 21.5″.

In various other embodiments the grill grate support system may have any shape or dimension so as to conform to the shape of the grill for which is intended to be used. In these other embodiments the thickness of perimeter pieces and cross bars may vary so as to provide adequate support for any grill grate sections that may be placed on them. Also, in these other various embodiments the number of cross bars may vary so as to provide adequate support given the size and shape of the perimeter needed.

What is claimed is:

1. A cooking grate assembly comprising a plurality of independently disposed, dynamic members comprising:
at least one separate grate section.

2. The cooking grate assembly of claim 1 wherein said support piece removably attached to the said at least one separate grate comprises:
a weather-resistant, non-stick construction material; and
a means for lifting said at least one separate grate section.

3. The cooking grate assembly of claim 2 wherein said at least one separate grate section comprises; three distinct sections.

4. The cooking grate assembly of claim 3 wherein the three distinct sections further comprise:
a center-section perimeter bar;
a center-section cross bar having a first end and a second end;
at least five center-section placement bars, wherein each placement bar has a first end, a second end, and a center point.

5. The cooking grate assembly of claim 3 further comprising;
a left grill grate section comprising:
a left-section perimeter bar;
a left-section cross bar;
at least one left-section placement bar, wherein said placement bar has a first end a second end, and a center point.

6. The cooking grate assembly of claim 5 further comprising;
a right grill grate section comprising;
a right-section perimeter bar;
a right-section cross bar; and
at least one right-section placement bar, wherein said placement bar has a first end a second end, and a center.

7. The cooking grate assembly of claim 4 wherein the construction material for the center-section perimeter bar, center-section cross bar and the center-section placement bars comprise cast-iron with a porcelain enameled finish.

8. The cooking grate assembly of claim 5 wherein the construction material for the left-section perimeter bar, left-section cross bar and the left-section placement bars comprise cast-iron with a porcelain enameled finish.

9. The cooking grate assembly of claim 6 wherein the construction material for the right-section perimeter bar, right-section cross bar and the right-section placement bars comprise cast-iron with a porcelain enameled finish.

10. The cooking grate assembly of claim 7 wherein the center-section perimeter bar further comprises:
a first curved side having a first end point, a second end point and a center;
a second curved side located opposite the first curved side having a first end point, a second end point and a center;
a first straight side having a center point; and
a second straight side located opposite the first straight side having a center point.

11. The cooking grate assembly of claim 10 wherein the first end of each center-section placement bar is attached to the first curved side of the center-section perimeter bar;
the second end of each center-section placement bar is attached to the second curved side of the center-section perimeter bar by; and
the center-section cross bar is attached to the center of each placement bar and to the center-section perimeter bar on the center point of the first straight side and on the center point of the second straight side's center.

12. The cooking grate assembly of claim 11 wherein the center-section placement bars contact the center-section perimeter bar lying parallel to each other and the straight sides of the perimeter bar so that the placement bars;
perpendicularly contact the center-section cross bar wherein;
the distance between placement bars are all equal wherein;
the center-section placement bars contact and do not extend beyond the perimeter bar's edge; and
are attached at all points of contact to the center-section perimeter bar and center-section cross bar.

13. The cooking grate assembly of claim 5 wherein the left-section perimeter bar further comprises;
a curved side comprising a left-wing side, a right-wing side and a center point; and
a straight side comprising a center point.

14. The cooking grate assembly of claim 13 wherein;
the first end of the left grill grate section placement bar is attached to said left-wing side;
the second end of the left grill grate section placement bar is attached to said right-wing side;
the left-section cross bar is attached to each left-section placement bar, the left-section perimeter bar's curved side, and the left-section perimeter bar's straight side at each of their respective centers;
the ends of the left-section placement bars overlap the left-section perimeter bar so that the endpoints of said perimeter bars contact, but do not extend beyond the edge of the said perimeter bar and are attached to the perimeter bar at the points where contact is made; and
the centers of the said placement bars overlap and are attached to the left-section cross bar.

15. The cooking grate assembly of claim 6 wherein the right-section perimeter bar comprises;
a curved side comprising a left-wing side, a right-wing side and a center point; and
a straight side comprising a center point.

16. The cooking grate assembly of claim 15 wherein;
the first end of the right grill grate section placement bar is attached to said right-wing side;
the second end of the right grill grate section placement bar is attached to said right-wing side;
the right-section cross bar is attached to each right-section placement bar, the right-section perimeter bar's curved side, and the right-section perimeter bar's straight side at each of their respective center points;
The ends of the right-section placement bars contact the right-section perimeter bar so that the endpoints of said perimeter bars contact, but do not extend beyond the edge of the said perimeter bar and are attached to the perimeter bar at the points where contact is made; and
The centers of the said placement bars contact and are attached to the right-section cross bar.

17. The cooking grate assembly of claim 1 wherein the support piece comprises:
a support piece perimeter bar comprising stainless steel; and
At least one support piece cross bar comprising stainless steel, a first end point and a second end point.

18. The cooking grate assembly of claim 17 wherein the support-piece perimeter bar is attached to the first end and second end of the said at least one support piece cross bars so that said at least one support piece cross bar runs the full inside diameter of the support-piece perimeter bar.

19. A method of assembling a multi-sectioned replacement grill grate system that has a non-stick surface that is resistant to weathering, easy to clean and for use with a grill comprising the steps of:
creating a composite building material by selecting a strong rigid base material, and coating it with a second material that is non-stick, resistant to weathering and easy to clean;
assembling two or more separately detachable grill grate sections, comprised of said composite building material, such that any grate section may lay next to an other grate section wherein all sections when laid out next to their proper neighboring grate section will cover the original grilling surface of a grill, but allow for easy access to the fuel source by the removal of at least one grill grate section;

20. The method of assembling a multi-sectioned replacement grill grate system in claim 19 where the composite building material is cast-iron coated in porcelain.
